(19) United States
(12) Patent Application Publication
(10) Pub. No.: US 2018/0144244 A1
(43) Pub. Date: May 24, 2018

(54) DISTRIBUTED CLINICAL WORKFLOW TRAINING OF DEEP LEARNING NEURAL NETWORKS

(71) Applicant: Vital Images, Inc., Minnetonka, MN (US)

(72) Inventors: Osama Masoud, Woodbury, MN (US); Oliver Schreck, Chaska, MN (US)

(21) Appl. No.: 15/443,547

(22) Filed: Feb. 27, 2017

Related U.S. Application Data
(60) Provisional application No. 62/425,656, filed on Nov. 23, 2016.

(51) Int. Cl. G06N 3/08; G06N 3/04; G06F 19/00

(52) U.S. Cl. CPC G06N 3/08; G06F 19/321; G06N 3/04

(57) ABSTRACT

Techniques for training a deep neural network from user interaction workflow activities occurring among distributed computing devices are disclosed herein. In an example, processing of input data (such as input medical imaging data) is performed at a client computing device with the execution of an algorithm of a deep neural network. A set of updated training parameters are generated to update the algorithm of the deep neural network, based on user interaction activities (such as user acceptance and user modification in a graphical user interface) that occur with the results of the executed algorithm. The generation and collection of the updated training parameters at a server, received from a plurality of distributed client sites, can be used to refine, improve, and train the algorithm of the deep neural network for subsequent processing and execution.

### PRIORITY CLAIM

This application claims the priority benefit of U.S. Provisional Application Ser. No. 62/425,656, filed Nov. 23, 2016, which is hereby incorporated by reference in its entirety.

### TECHNICAL FIELD

Embodiments pertain to data processing techniques and configurations used with information networks and informatics systems. Further embodiments relate to the use and training of neural networks used in medical diagnostic and evaluative settings, including medical imaging display and management workflows.

### BACKGROUND

As healthcare processes have become increasingly digitized, large volumes of patient data is now generated on human patients at nearly every medical facility for many types of healthcare interactions. A number of artificial intelligence and computer-assisted evaluation algorithms have been designed to consume and evaluate patient-based data from these healthcare interactions, including with algorithms that perform automated operations or generate computer-assisted findings and predictions. For example, artificial intelligence and computer-assisted algorithms are increasingly used in fields such as radiology to identify certain anatomical features in medical images. The analysis of patient data with such artificial intelligence and computer-assisted algorithms can greatly assist and guide healthcare professionals to deliver healthcare services and make clinical decisions.

Recent advances in machine learning, including deep learning neural network configurations, have offered improved approaches for collecting, parsing, and utilizing the large volume of medical information being collected from patients. However, the accuracy of algorithms and models that are used in machine learning is often limited to the extent that the underlying algorithm and model has been trained. Some approaches for improving the accuracy of machine learning models have suggested the use of distributed learning and training, to expand the base of information and types of actions from multiple actors to improve accuracy. However, such approaches are often implemented with ad-hoc feedback, and have limited applicability to a specific type of neural network or use case.

### BRIEF DESCRIPTION OF THE DRAWINGS

FIG. 1 illustrates a block diagram of a system configuration for use and deployment of a deep learning neural network configured for processing medical information according to an example described herein.

FIG. 2 illustrates an overview of a distributed feedback and training process for a deep learning neural network implemented among respective client sites and a centralized training server, according to an example described herein.

FIG. 3 illustrates a system diagram depicting training and deployment operations for a deep learning neural network according to an example described herein.

FIG. 4 further illustrates a system diagram depicting data collection and processing operations within an operational workflow using a deep learning neural network according to an example described herein.

FIG. 5 illustrates a flowchart of a method performed by a centralized processing server for deploying and updating a deep learning neural network to distributed clients according to an example described herein.

FIG. 6 illustrates a flowchart of a method performed by a distributed client for updating parameters of a deep learning neural network according to an example described herein.

FIG. 7 illustrates a block diagram of a system used for distributed deployment and training of a deep learning neural network according to an example described herein.

FIG. 8 illustrates an example of a machine configured to perform computing or electronic processing operations according to an example described herein.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments.

The present disclosure illustrates various techniques and configurations that enable enhanced training of machine learning networks through user actions that occur in respective workflows at multiple, distributed locations. Such workflows include clinical workflows that are undertaken by medical professional users within medical information processing settings. The techniques and configurations disclosed herein may be used to identify differences from a machine learning model that have been applied, modified, or rejected within a clinical workflow, including differences that occur within respective workflows for clinical users who are distributed across a large network of medical facilities. The resulting differences that are identified from the various workflow uses of the model may be collected and processed as training data (e.g., reinforcement or correction data) for the machine learning model-thus, improving future iterations and applicability of the machine learning model.

The following operations can be used to obtain training data for a variety of machine learning models and model types, including specialized deployments of deep learning neural networks that are intended for a specific workflow task as part of a larger processing workflow (such as a medical imaging review workflow). Further, the training data collection process allows the collection of relevant training information for feedback of one or multiple deep learning network layers from a large network of sites. This feedback can be obtained and utilized without transferring confidential patient data and without interfering with the use of existing verified workflows by medical professionals.

As used herein, the term “workflow” generally refers to a sequence or collection of events, activities, process steps, or actions, which may include human-interactive or modified actions, to produce an output (e.g., result or effect) on some input (e.g., data). Many workflows are performed every day on medical data by medical professional users, including in diagnostic, evaluative, and review settings. The user interactions provided in such workflows provide an opportunity for capturing valuable machine learning data and information on manual actions that can be automated or validated. Thus, in the machine learning sense, user feedback information from these medical processing workflows can be captured and “learned”. This user feedback information can be used to create and improve machine learning models and algorithms that can achieve a high degree of accuracy for automation and processing activities. Such processing activities may include, and are not limited to, detecting certain information objects in data, modifying characteristics of the data, quantifying certain types of data characteristics, making accurate predictions or forecasts regarding the data characteristics, or performing other types of data processing actions.

In some of the examples discussed herein, the training process is achieved through configuration of a distributed network that gathers the corrections and user interactions made by each expert at a distributed computing system (and the respective facility) after application of a machine learning algorithm. These corrections and user interactions may be fed into the training procedure of a deep learning network at a centralized server. For example, these corrections then can lead to training of the artificial neural network for an improved version (and subsequent distribution) of the machine learning algorithm. This improved version may be further utilized, evaluated, tested, and improved even further before being incorporated into a released version of the machine learning algorithm.

The distributed training approaches discussed herein addresses several challenges with traditional training approaches of deep learning networks, including the availability of new data for training, the hardware resources needed to process training data, and the volume of human activity needed to provide accurate training data. With the use of the present techniques, accuracy and efficiency of a machine learning model (and its generated algorithms) may be improved significantly. Such accuracy and efficiency may result in improved automation of previously manual activities, reduction in errors and inaccurate activities, and improved efficiency of software operations and associated processing and networking hardware resources. Further, the techniques provide improvements over conventional training approaches for machine learning networks, allowing improved computational results in reduced time.

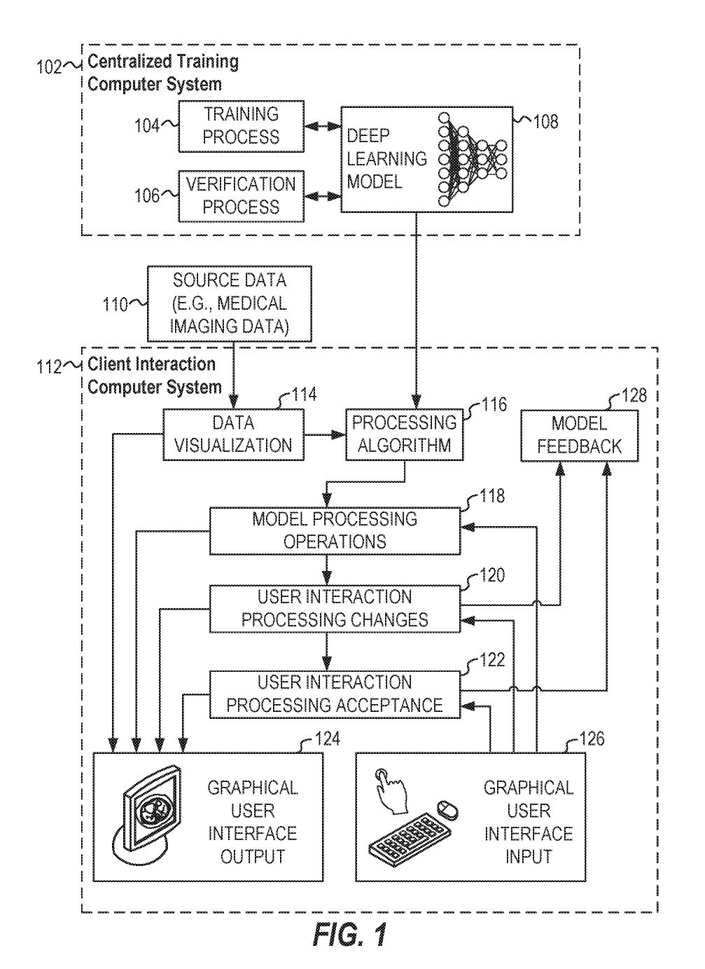

FIG. 1 illustrates an overview of a system configuration for use and deployment of a deep learning neural network, for an example artificial neural network model that is configured for processing medical information. Specifically, FIG. 1 illustrates a workflow involving the use of a deep learning neural network adapted for the processing of source data 110 (e.g., medical imaging data). It will be understood that the system configuration of FIG. 1 is arranged into high-level components for purposes of illustration, and individual features of the depicted components and workflow activities may be integrated or separated among various machines, systems, and devices. Further, many of the processes and functions depicted in the following example may be simulated or replicated by like functions within consolidated or separated device subsystems.

As shown in FIG. 1, the source data 110 is provided to a client interaction computer system 112 for processing with workflow operations. This source data 110, in some examples, may include two- or three-dimensional image data of a human subject, such as image data acquired from an imaging modality (e.g., an x-ray machine, computed tomography (CT) scanner, magnetic resonance imaging (MRI) machine, and the like). The source data 110 may be directly or indirectly provided from a specialized medical imaging system such as a picture archiving communication system (PACS), or other image data retrieval, caching, or storage systems. The format of the source data 110 may be in a proprietary or industry standard format, such as in a Digital Imaging and Communications in Medicine (DICOM) format, which may be further processed or consolidated by a medical imaging system prior to processing in the operational workflow. Although the following examples refer to the processing of medical imaging data, the following techniques may be used with other types and forms of the source data 110.

As shown, the client interaction computer system 112 operates to perform a series of workflow operations on the source data 110, such as features of data visualization 114 that are used to display and change (e.g., augment, highlight, change, modify, remove, segment, etc.) features of the medical images from the source data 110. The data visualization 114 may be used to provide an output a representation of the medical images on a graphical user interface output 124. The graphical user interface output 124 may be provided via a display device (e.g., monitor, screen, etc.) connected to the client interaction computer system 112.

In the context of the client interaction computer system 112, the “workflow” generally refers to a series of operations performed with some combination of manual (human-specified) and automated activity, to perform a task. One example of a workflow in the medical imaging field of use is a radiology read workflow, where a series of diagnostic images (e.g., produced by an imaging modality) are evaluated by a reviewing medical professional (e.g., a radiologist) to produce a diagnosis directly from the medical images. Another example of a workflow in the medical imaging field of use is an image review workflow, where captured medical images may be manipulated and evaluated by a clinician (e.g., a specialist, doctor, or other trained professional), such as to perform segmentation, quantification, or prediction of anatomical features of a medical image to confirm a diagnosis or observe the state of a particular medical condition. Other examples of workflows may involve other types of actions, feedback, and control that occur from interaction with a human user or users in a software application or accompanying computer system. Although this example is described in relation to medical image data processing, it will be understood that similar workflows involving other forms of medical data, and non-diagnostic or non-medical actions, may also be performed. Further, the automated or computer-assisted workflow operations for detection, segmentation, quantification, or prediction discussed herein may be applicable in both medically diagnostic and non-diagnostic (e.g., informational, educational, demonstrative, etc.) settings.

As shown, the client interaction computer system 112 receives a processing algorithm 116 that is produced from a trained version of a deep learning neural network model 108. This deep learning model 108 may be generated by a centralized server 102 (e.g., a training computing system) through use of a training process 104 and a verification process 106. The training process 104 may involve the detection and reinforcement of actions and paths, such as generated from a large set of initial training data.

The processing algorithm 116 produced from the deep learning model 108 may perform any number of automated processing activities in connection with the source data 110, including features of detection, segmentation, quantification, prediction, automation, or validation. The deep learning model 108 may be used to produce one or multiple algorithms, such as specialized algorithms for each desired task, activity, or workflow.

The workflow activities that interact with the data visualization 114 may include information inputs, confirmations, modifications, and like activities being performed by client users (e.g., medical personnel). This may include portions of medical experts' reading and interpretation workflows that are performed for the diagnostic review and evaluation of medical imaging data. Thus, the model processing operations 118 may be used to provide automation for portions of a reading and interpretation workflow, as the workflow generates model feedback 128 produced from user interactions. As discussed below, this model feedback 128 can be used to improve the performance of existing and new algorithms applied for the deep learning model 108.

In an example, the data visualization 114 and the features provided in the graphical user interface output 124 are directly provided through use of the processing algorithm 116, designed to perform a specific automated or computer-guided task. The application of the processing algorithm 116 in connection with features of the data visualization 114 may be accomplished through one or more model processing operations 118, which are directed by user input in response to a graphical user interface input 126 (e.g., touch, keyboard, mouse, gesture, voice, haptic input). Different tasks of the model processing operations 118 that are performed in the graphical user interface output 124 may employ different processing algorithms. Thus, a single workflow on a single set of source data 110 may involve the application of multiple processing algorithms and model processing operations 118. The model processing operations 118 may be controlled through human input obtained via the graphical user interface input 126, to cause a change to the output being provided in the graphical user interface output 124.

The workflow is further shown in FIG. 1 as being affected by one or more user interaction processing changes 120 and user interaction processing acceptance 122. The user interaction processing changes 120 and the user interaction processing acceptance 122 may be provided under direct control (e.g., user interface inputs) provided with the graphical user interface input 126. The user interaction processing changes 120 and the user interaction processing acceptance 122 may modify, accept, or reject characteristics of the data visualization 114 and model processing operations 118 provided in the graphical user interface output 124. For example, the user interaction processing changes 120 may manually change the result of an automated action (such as to change the location of an anatomical outline of a medical image detected with the processing algorithm 116). The user interaction processing acceptance 122 also may occur from the acceptance or rejection of an automated action.

In response to the user interaction processing changes 120 and the user interaction processing acceptance 122, a set of model feedback 128 may be generated. This model feedback 128 may be used to provide improvement for the deep learning model 108, which is used to generate a subsequent version(s) of the processing algorithm 116. Respective versions of the model feedback 128 can be provided from a large number of computing systems, from distributed use cases, to generate new training for multiple features and layers of the deep learning model 108. The model feedback 128, when collected in combination with other distributed feedback from other client computer systems and other executions of the processing algorithm 116, may be input into the training process 104 and the verification process 106 at a later time. The generation of the feedback for the deep learning model 108 thus may occur in a distributed and recurring fashion.

The availability of training data is particularly challenging in the medical domain for a variety of reasons, including the general scarcity of new training data, logistics involved in properly anonymizing patient data, issues of consent and data ownership, and the bandwidth required to transfer this typically large set of data (e.g., medical images). Ideally, for a specific clinical finding, a group of different evaluators would perform separate evaluations and annotations in order to account for inter-reader variability. The distributed approach described herein aims at meeting the training data needs of deep learning models while increasing the size of training data and improving the quality of any produced algorithm.

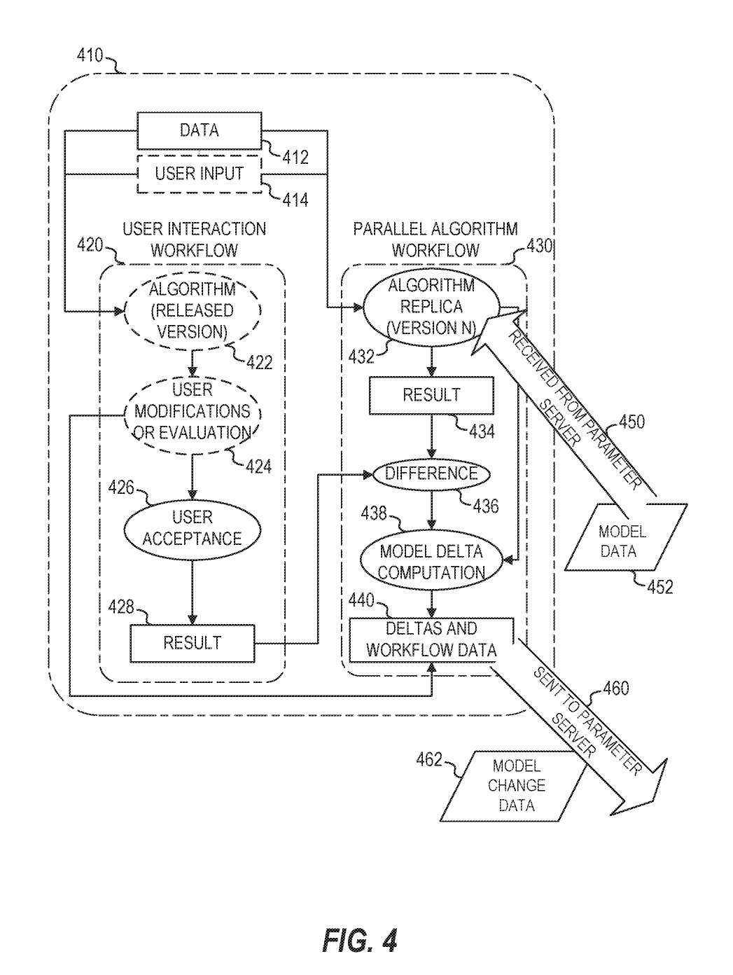

With the present approach, training can take place in an on-line, interactive fashion, to allow one or more deep network algorithms to be updated continuously as additional training data becomes available from any site. The training process 104 thus can occur in a distributed way: part of the training is performed at the distributed, client interaction computer system 112 (to produce specific model feedback 128 from user interaction); and the other part of the training is performed at the centralized server 102 that multiple client sites communicate with. In some examples, the communication between the site providing the results and the centralized server 102 can be two-way and fully automated. Also in some examples, the improvements collected with the model feedback 128 may be deployed only temporarily at the distributed sites through use of parallel comparison workflows (described further below in reference to FIG. 4), such as parallel comparison workflows that operate in the background and do not affect a clinical workflow.

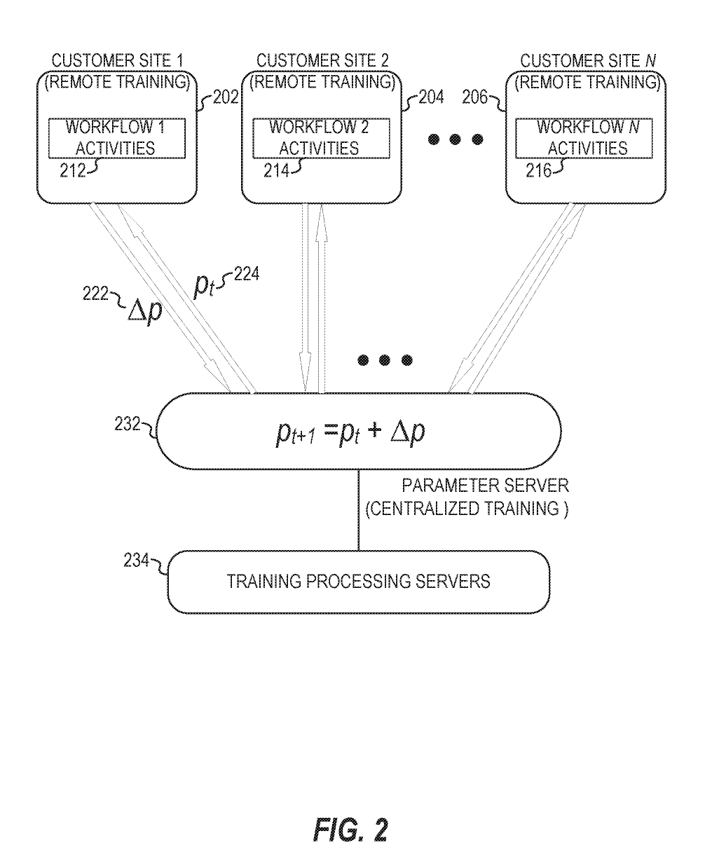

FIG. 2 illustrates an overview of an example distributed feedback and training process for a deep learning neural network implemented among respective client sites and a centralized training server. As shown, FIG. 2 illustrates the use of training activities in a workflow deployed at respective client sites, including customer site 1 202, customer site 2 204, and customer site N 206. Each of the customer sites (202, 204, 206 perform respective workflow activities, including workflow 1 activities 212, workflow 2 activities 214, and workflow N activities 216. As already discussed, such workflow activities 212, 214, 216 may include data visualization or processing operations involving image data, including human-interactive operations.

In deep learning scenarios, the goal of the training process is to update the model with more suitable parameters, based on how the model agrees with the training data. As shown in FIG. 2, the centralized system may operate a parameter server 232 that maintains model parameters used in the execution of respective processing algorithms; the centralized system may also operate or coordinate with one or more training processing servers 234 that host model replicas, perform training, and determine the resultant parameter adjustments for model changes. Each of the workflow activities 212, 214, 216 that are executed at the respective customer sites 202, 204, 206 are executed based on a specific set of parameters for a deep learning model that are communicated and deployed at the respective customer sites from the parameter server 232. The parameters for the deep learning model that are communicated to the customer site 1 202, for example, are shown with parameters pₜ 224. (Other parameters that are unique to the algorithm or version of the algorithm are likewise deployed to the other customer sites).

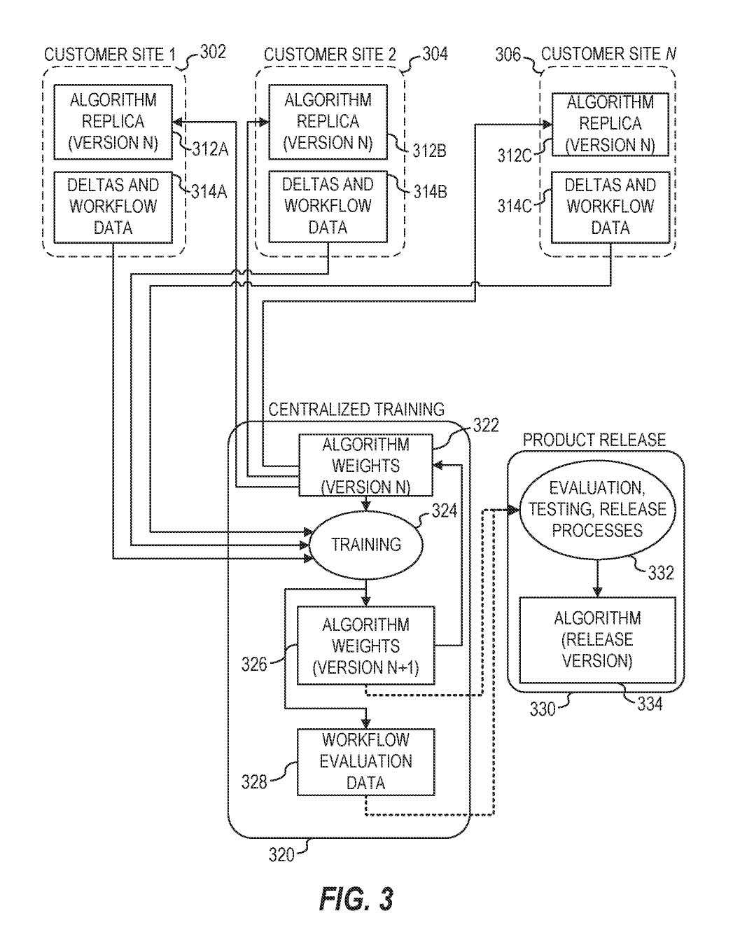

As discussed below in relation to FIGS. 3 and 4, a difference between the parameters provided to the distributed client site and the parameters actually used in the workflow activities, represented by Δp, may be computed at the respective client sites and tracked for purposes of model training. As shown, Δp 222 for the workflow 1 activities 212 that are performed at the customer site is computed and communicated back to the parameter server 232. At a later time, the subsequent parameters that the parameter server 232 provides for the model, pₜ₊₁, can be generated based on a combination of pₜ and Δp (in other words, reflecting the changes to the pₜ 224 parameters based on the workflow 1 activities 212 that were modified or accepted by user interaction). Although not shown, it will be understood that the other parameter differences (deltas) and feedback provided from the other workflow activities (214, 216) at other customer sites (204, 206) may also be used to update the subsequent parameters for pₜ₊₁.

In an example, the parameter server 232 updates the current model parameters (e.g., weights) with, or based on, the deltas received from the distributed sites (e.g., model change data from sites 202, 204, 206), thereby creating a new version of the model. The deltas may be applied sequentially so that there is one operational model version at all times. In further examples, one or more delta updates may be intentionally ignored or disregarded if the update values are out of date (e.g., if the deltas come from a site that has applied a sufficiently old version of the model) or if the update values seem erroneous (e.g., if the deltas make the model perform noticeably worse on a set of test data).

The communication of the parameters from the distributed workflow sites can provide an easy-to-process indication of changes and reinforcements to the model algorithm. This allows the model to be trained and adapted from human workflow actions at the location where the data is actually presented, used, changed, and accepted. This configuration further uses clinical workflow activities as they are being performed to achieve learning in a way that is distributed and is an integral part of, while invisible to, the clinical processing tasks and activities.

One important benefit of the use of parameters and parameter differences is that it can prevent reverse engineering of sensitive data processed at the distributed sites. Thus, training data for a workflow can be produced even through it is not possible to identify the content of the patient data or the clinical findings produced from the workflow. This provides significant benefits over the provision of logging data that may include personally identifiable information (e.g., legally-protected personal health information).

The present techniques thus provide an implementation of large scale distributed training, to scale training actions among multiple clients in order to accelerate the training process. This also enables the collection of feedback from experts and workflow actions that are naturally distributed, because each processing site has its own data and experts. Compared to the traditional algorithm development process of data collection and re-training, the distributed model feedback and training procedure is thus far more scalable to a large number of workflow activities and workflow locations.

The present techniques also offer a significant advantage over existing training techniques. The present distributed training technique is provided with access to a significantly larger training data size, which can translate to higher accuracy of the resulting algorithm. Additionally, the distributed nature of the processing allows individual and discrete actions to occur without requiring a complex, multi-processor platform for computation and data extraction (or the use of advanced computer architectures, as may be required with some existing neural network configurations).

FIG. 3 illustrates a system diagram depicting training and deployment operations for a deep learning neural network according to an example described herein. In a similar fashion as previously described, FIG. 3 includes respective customer sites 302, 304, 306 that perform processing of source data (e.g., imaging data) with use of an algorithm 312A, 312B, 312C produced by a machine learning model. The respective customer sites 302, 304, 306 are shown as including a common version (version N) of the algorithm 312A, 312B, 312C, which utilizes a versioned set of algorithm weights 322.

The configuration of FIG. 3 is designed to allow the algorithm to undergo continuous training even as the respective users of the customer sites 302, 304, 306 perform normal workflow activities. Whenever a user performs a task, such as correcting automatically generated results or manually creating a result outcome (that is relevant to the processing of the algorithm), a training opportunity emerges. This analysis can be performed in the background on the user's system, in a secondary (parallel) evaluation workflow, without impacting the user's primary workflow. The output of the analysis may be deltas (e.g., differences or comparison results between two sets of algorithm parameters) and other forms of workflow data that reflects change to or differences from the workflow operations. The process that occurs at a respective client site using dual workflows is described below in more detail with reference to FIG. 4.

In an example, the output of the distributed training process includes one or more neural network weight adjustments, as determined from the respective deltas and workflow data 314A, 314B, 314C. Such adjustments (deltas) may be accompanied by workflow data that is provided to a central parameter server (shown in FIG. 3 as centralized server 320), and processed in the training process 324 with a backpropagation training technique for the model. As the deltas and workflow data are received by the centralized server 320 from the respective distributed clients, weight adjustments for the neural network may be determined and applied to the model being trained, with the training process 324. The updated model produced from the training process 324, which includes a new version of the algorithm weights 326 (weights N+1), then can be broadcast back to the distributed sites, automatically or as the result of a future update deployment.

In some examples, an existing version of an algorithm may be updated with a new set of weights, and this new set of weights then may be distributed to the respective clients for further use and testing. In other examples, an entirely new algorithm (e.g., with new neural network processing nodes for different processing actions) can be generated and distributed to the respective clients. In either case, the use of updated algorithm weights or an updated model algorithm may be further evaluated, tested, and observed in a product release evaluation 332 performed by a product release server 330. The result of the product release evaluation 332 may be a released, verified version of the algorithm 334 that incorporates one or multiple version improvements from the training process 324. Additionally, the results of the training process 324 may be used to generate workflow evaluation data 328 that is then evaluated and tested by the product release server 330, such as to verify that the condition identified in the workflow evaluation data 328 is adequately handled by the released version of the algorithm 334.

The frequency that the feedback parameters are communicated from respective client sites to the centralized server for the training process 324 may be automated and dependent on several factors, such as the time interval since the last transfer, the number of relevant workflows that were completed, the system load, the time of day, etc. As these adjustments are received by the centralized server 320, they may be automatically applied to the model being trained. In an example, the updated model or changes to the model are then broadcast back to the sites automatically for further use, testing, and refinement. The broadcast frequency of an automatically updated model may also depend on multiple factors. Likewise, updated weights or an updated algorithm for the model may be communicated to the distributed sites with an automated, scheduled, or on-demand basis.

FIG. 4 further illustrates a system diagram depicting data collection and processing operations within an example operational workflow using a deep learning neural network. As shown, FIG. 4 includes features of a specific distributed client site 410 that is adapted to process input data 412 and optional user input 414 within a user interaction workflow 420 (e.g., a clinical image evaluation workflow). It will be understood that the input data 412 may be analyzed by other workflows and algorithms, depending on the specific workflow operations to accomplish.

As shown, a released version of the algorithm 422, version N, may be optionally employed on the inputs (data 412 and user input 414) of the user interaction workflow 420 to perform automated workflow actions. In an example where automated processing actions are performed with the algorithm 422, a parallel algorithm workflow 430 can also operate to collect and determine training data for the algorithm, using an alternate version (e.g., newer or experimental version) of the algorithm. During the performance of the user interaction workflow 420, the parallel algorithm workflow 430 may be presented with the same inputs (input data 412 and user input 414) as the released version of algorithm used for the user interaction workflow 420.

In other examples, the user interaction workflow 420 may be a manual workflow involving a series of manual processing actions, which are observed and used to train an algorithm to automate the manual workflow actions. For example, a medical imaging visualization application that allows a human user to locate colon polyps may involve manual user input, such as in a scenario where the human user identifies (e.g., clicks on) each polyp that is located in the images; such identification information can be used to train a deep learning network to locate locations of polyps automatically from medical image data.

The processing operations (e.g., manual or automated operations) of the user interaction workflow 420 are followed by optional user modifications or evaluation operations 424, and user acceptance of the processing operations 426 (and any modifications). The user acceptance and any user modifications are then produced into a user interaction workflow result 428. For example, once the user makes an acceptance gesture (e.g., clicking OK, exporting evidence, or generating a report), the user interaction workflow result 428 is treated as ground-truth.

In a concurrent fashion, the alternate version of the algorithm 432 operates in the parallel algorithm workflow 430. The processing operations of the alternate version algorithm on the input data 412 then produce a parallel workflow result 434. This parallel workflow result 434 is then generated into a compared difference 436 between the user interaction workflow result 428 and the parallel workflow result 434. The parallel algorithm workflow 430 further operates to generate a model delta computation 438 to determine a difference between the model data 452 (e.g., algorithm weights and other parameters) received from the parameter server 450 and the compared difference 436 determined from use of the user interaction workflow 420 (e.g., the user interaction workflow result 428). The parameter differences (deltas) determined by the model delta computation 438 and any associated workflow data 440 are then produced, and communicated as model change data 462 when sent to the parameter server 460.

The loss function that drives training (e.g., the model delta computation 438) depends on the user interaction workflow result 428 obtained by the algorithm being trained. For example, the data that is sent to the parameter server 460 may include model weight adjustments that are obtained by standard backpropagation optimizers. Such model weight adjustments and other selective workflow metrics may be communicated in the model change data 462 returned to the centralized parameter server 460. Data augmentation techniques can also be employed in this phase by feeding the input data after having gone through parameterized random transformations to the algorithm being trained, and by applying the same transformations to the ground-truth.

In a specific image processing example, a result of a deep learning network segmentation algorithm may provide a probability value for each pixel (or voxel) indicating how likely it is that this pixel is part of the segmentation. A user edited and accepted result (e.g., the ground-truth from the user interaction workflow result 428) may provide a binary assignment (i.e., a probability of 0 or 1) for each pixel indicating whether it is outside or inside the segmentation. Using a typical backpropagation technique, standard loss functions (such as cross-entropy error) can be used to calculate the required change in the model weights that will make the model generate pixel probabilities that are closer to the ground-truth given the same input. To accomplish this, the backpropagation algorithm may use the loss function, the full model architecture, the model weights, and other parameters such as a learning rate, to determine and generate changes.

In an example, the parameter server will generate an updated version of the algorithm (e.g., a new alternate version of the algorithm 432) on-demand, in response to the deltas and workflow data provided in the model change data 462. The parameter server will then send the updated version of the algorithm (or algorithm parameters) to the distributed clients in an immediate fashion or according to some update schedule or criteria. The “release version” of the algorithm used for execution in the user interaction workflow 420, however, is intended to be distributed in a software release schedule, such as for distribution to clinical users (including users who are involved in the distributed feedback process and users who are not). The “non-released” version of the algorithm that goes through the cycles of training, in contrast, can be simply executed in the parallel algorithm workflow 430 and is not used clinically. For example, the non-released version may be updated several times a day, whereas the release version may be updated once every few months.

Thus, as shown in FIG. 4, training activities may be conducted in a secondary, training workflow (e.g., the parallel algorithm workflow 430) even as the training activities are invisible to and do not affect a released, clinical workflow (e.g., the user interaction workflow 420). Monitoring of the algorithm's training progress and outcomes can take place at any desired frequency, with a number of possible measures. One such measure is performance on test data that was never used during the training process. It is expected that if the model is continuously being trained on real examples and quality ground-truth, the model will perform progressively better on test data. Such test data can be increased in size over time as well. Another measure is workflow metrics that may be collected from distributed sites. The measurement of workflow metrics may take many forms, for example, number of clicks to achieve the task or time duration the user spends to achieve it. Such metrics are also expected to improve if the algorithm has improved. However, since the user workflow (e.g., the user interaction workflow 420) is not impacted by the algorithm being trained, these metrics may be a lagging indicator of improvement and can also be used during alpha testing.

A decision to release an algorithm for actual workflow use (e.g., in the user interaction workflow 420 or other clinical workflow) will depend on the measured progress as well as release processes. Once an algorithm is released, it will become the model used by the distributed users when the workflow is performed. In a parallel workflow that does not impact the user, the algorithm can still undergo the training process described above in order for yet another improvement targeting a future release.

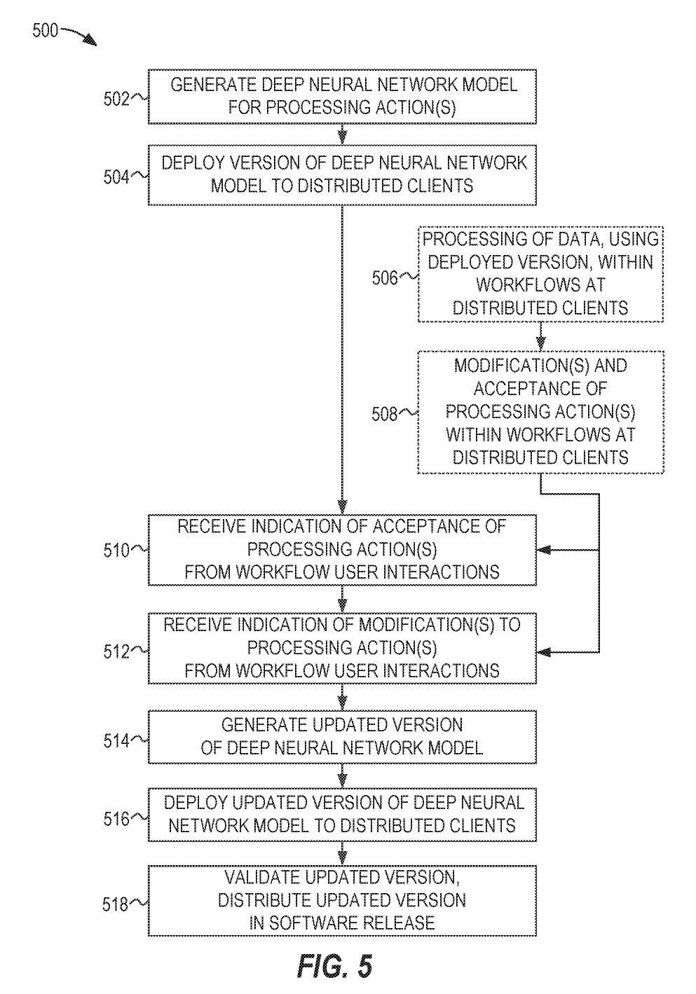

FIG. 5 illustrates a flowchart 500 of an example method performed by a centralized processing server for deploying and updating a deep learning neural network to distributed clients. As shown, the flowchart 500 depicts a set of sequential operations to effect training for a deployments of the deep neural network that are used in a distributed client workflow (e.g., for processing medical data). It will be understood that the summary of activities portrayed in FIG. 5 is provided for purposes of illustration, and many more detailed activities (including activities provided in another order or sequence) may occur with the operations at the server or respective clients.

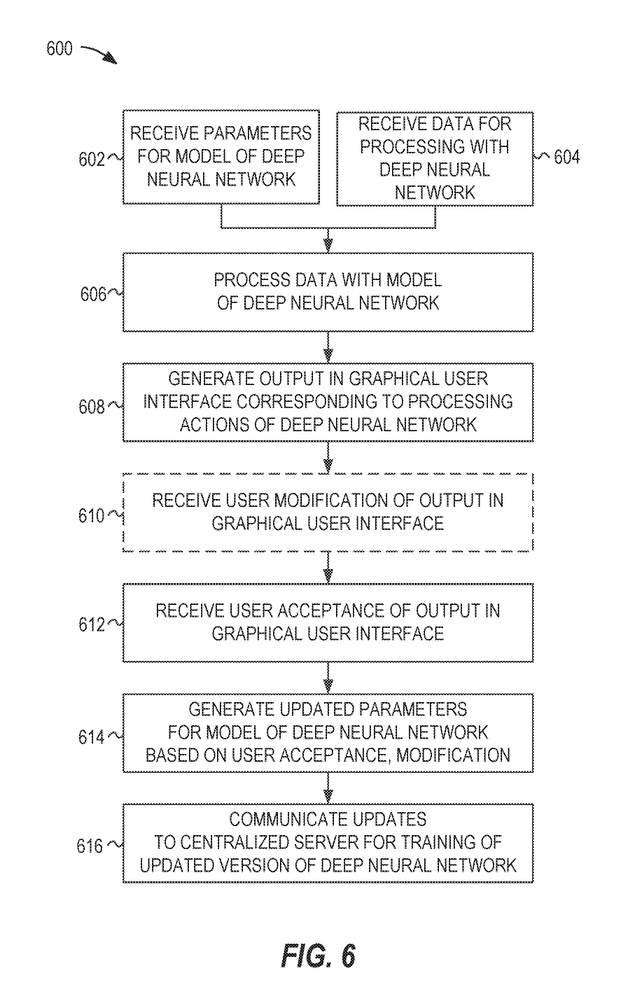

The flowchart 500 initially depicts the generation of a deep neural network model to perform automated processing actions (operation 502), such as the generation of a model for image data and visualization processing operations in a graphical user interface. The deep neural network model and any accompanying software binaries, algorithms, and parameters, is deployed to respective distributed clients (operation 504) such as computing systems at respective medical facilities. This is followed by the processing of the source data using a deployed version of the deployed deep neural network model, within respective workflows at the distributed clients (operation 506, illustrated as a client-side action). At the distributed clients, one or more modifications and acceptance of the processing action(s) occurs from user interaction in the respective workflows (operation 508, illustrated as a client-side action). This processing may include implementation of the operations described above with reference to FIGS. 3 and 4, and the flowchart 600 discussed below with reference to FIG. 6.

The flowchart 500 further depicts operations at the centralized server, to facilitate feedback and training data. These operations may include the receipt of one or more indications of processing actions from distributed clients, indicating acceptance of user interactions in respective workflows (operation 510) and modification of user interactions in respective workflows (operation 512). As discussed above with reference to FIG. 2, this information may be communicated to the centralized server in the form of parameter differences that have been observed in training data at the respective clients.

The indications and training data received from the respective clients may be used to generate features of an updated deep neural network model (operation 514), including updated parameters for execution in an algorithm of a neural network model, or the adaption of new or updated algorithm for the neural network model. This may be followed by deployment of an updated version of the deep neural network model to the distributed clients (operation 516). In further examples, additional testing and validation operations may be performed on the configuration of the updated version (or versions) of the deep neural network model (operation 518). For example, a software release that includes a set of algorithms produced from the updated deep neural network model may be provided as a verified clinical release to distributed and non-distributed software users.

FIG. 6 illustrates a flowchart of an example method performed by a distributed client for updating parameters of a deep learning neural network. This flowchart 600 provides a high-level depiction of operations used to generate the model data, but it will be understood that additional operations (including the integration of the operations from flowchart 500 and operations illustrated in FIGS. 3 and 4) may be optionally implemented into the depicted flow.

For example, the operations depicted in the flowchart 600 include the receipt of parameters for a model of the deep neural network (operation 602), and the receipt of data for processing with the deep neural network (operation 604). The receipt of the data for processing may occur before, concurrently with, or after the receipt of parameters (e.g., algorithm settings) for implementation of the deep neural network. For example, in the context of a workflow in a medical imaging visualization software application, a model (and algorithm) for the deep neural network may be deployed as executable code or a compiled binary to a distributed client viewer machine, which receives, processes, and analyzes characteristics of medical images using an algorithm reflecting prior training of the deep neural network.

As further shown in the flowchart 600, the data (e.g., image data) is processed with the model of the deep neural network (operation 606). This processing may be provided from software operations that generate output in the graphical user interface, including output that corresponds to acceptance, changes, or rejection to the processing actions of the algorithm produced by the model of the deep neural network (operation 608). (Such processing may occur in dual workflows, such as the user interaction workflow 420 depicted in FIG. 4 that occurs with a released version of an algorithm, and a parallel algorithm workflow 430 that occurs with a replica trained version of an algorithm.)

In some examples, user interaction with the output that is produced in the graphical user interface may optionally include user modifications that are received and applied to input data (operation 610), such as may occur by manual changes to automated effects applied to medical imaging visualization characteristics. In other examples, such modifications are optional and are not received or considered. Any potential user modification is followed by user acceptance of the automated processing actions, or the acceptance (or, rejection) of the effects of the automated processing actions in the output in the graphical user interface (operation 612).

Based on the user acceptance (and optionally, modification) operations, the distributed computing system may perform a comparison of user acceptance and modification activities to the expected processing actions of the deep neural network. This may include identifying manual user changes that are used to change output from the processing actions among one or multiple layers of the deep neural network model; identifying user acceptance or rejection of processing actions that is used to reinforce or de-emphasize characteristics of the deep neural network model; identifying automation of new or changed activities performed with user interaction in the workflow; and identifying other measured characteristics of user interaction (including additions, changes, subtractions, verification, validation) from workflow activities. These changes are reflected in a set of updated parameters for the model that are generated by the distributed computing system (operation 614). Finally, these updated parameters are communicated from the distributed computing system to a centralized location, such as a centralized server, for training of an updated model of the deep neural network (operation 616).

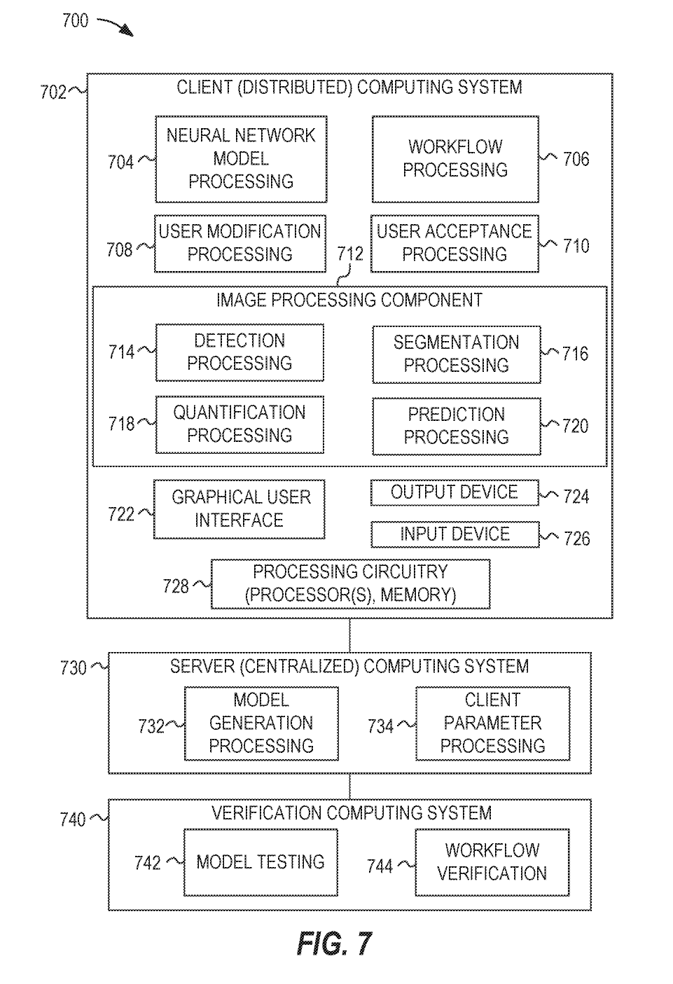

FIG. 7 illustrates a block diagram of components in a system 700 used for distributed deployment and distributed training of a deep learning neural network for image processing purposes according to an example described herein. For example, the system may include: a client computing system 702 (a distributed system) configured to implement a released (e.g., clinical) workflow and neural network model training (e.g., parallel testing) workflow using the techniques described herein; a server computing system 730 (a centralized system) configured to generate, train, update, and distribute a deep learning model and associated deep learning algorithms using the techniques described herein; and a verification computing system 740 configured to perform verification of the deep learning model and training actions of the deep learning model, as the model is updated from the client computing system 702 using the techniques described herein. The following examples specifically encompass configuration of the client computing system 702 and the server computing system 730 to support image processing functionality in client-side workflows with use of an artificial neural network (and specifically, a deep learning model); it will be understood that the configuration discussed herein is applicable to other types of workflows, data processing, and machine learning models.

The client computing system 702 may include components (e.g., programmed or specially arranged circuitry) for implementing an image processing workflow, through neural network model processing 704 that implements and executes a neural network algorithm; workflow processing 706 that executes a user interaction workflow and a parallel algorithm workflow with respective versions of a neural network algorithm; a user modification processing component 708 to receive and identify user modification actions occurring on output of the neural network algorithm; and a user acceptance processing component 710 to receive and identify user acceptance actions occurring on output of the neural network algorithm.

The client computing system 702 may further include an image processing component 712 to perform one or more image visualization or modification actions in a graphical user interface, such as for visualization and modification actions on human anatomical features in one or more medical images. The image processing component 712 may specifically implement functionality such as: detection processing 714 (e.g., for detecting human anatomical features, structures, or characteristics in medical images); segmentation processing 716 (e.g., for segmenting human anatomical features, structures, or characteristics in medical images); quantification processing 718 (e.g., for performing measurements, assessments, or evaluations of human anatomical features, structures, or characteristics in medical images); and prediction processing 720 (e.g., for performing estimations or predictions of human anatomical features, structures, or characteristics in medical images). The client computing system 702 may further include electronic components for user input, output, and processing, such as processing circuitry 728, a graphical user interface 722, an output device 724 (e.g., to provide output of the graphical user interface); and an input device 726 (e.g., to provide input for user workflow activities in the graphical user interface 722.) In a further example, the graphical user interface 722, the output device 724, and the input device 726 are used to engage the image processing components 714, 716, 718, 720 or other features of the neural network model processing 704 with use of the processing circuitry 728 to implement features of the workflow using the techniques described herein.

The server computing system 730 may include model generation processing 732 and client parameter processing 734. In an example, the model generation processing 732 is adapted to generate updated models and algorithms for the distribution of testing versions of a neural network model, and the client parameter processing 734 is adapted to receive and distribute updated client parameters (e.g., parameters indicating weights and programming values for the testing versions of the neural network model algorithm). The verification computing system 740 may include functionality for model testing 742 and workflow verification 744, such as for generation of updated models and algorithms to process clinical workflows for released, tested, and verified versions of a neural network model algorithm. In another example, the model testing 742 and workflow verification 744 features of the verification computing system 740 may be integrated or combined with the features of the server computing system 730 or the other centralized processing components.

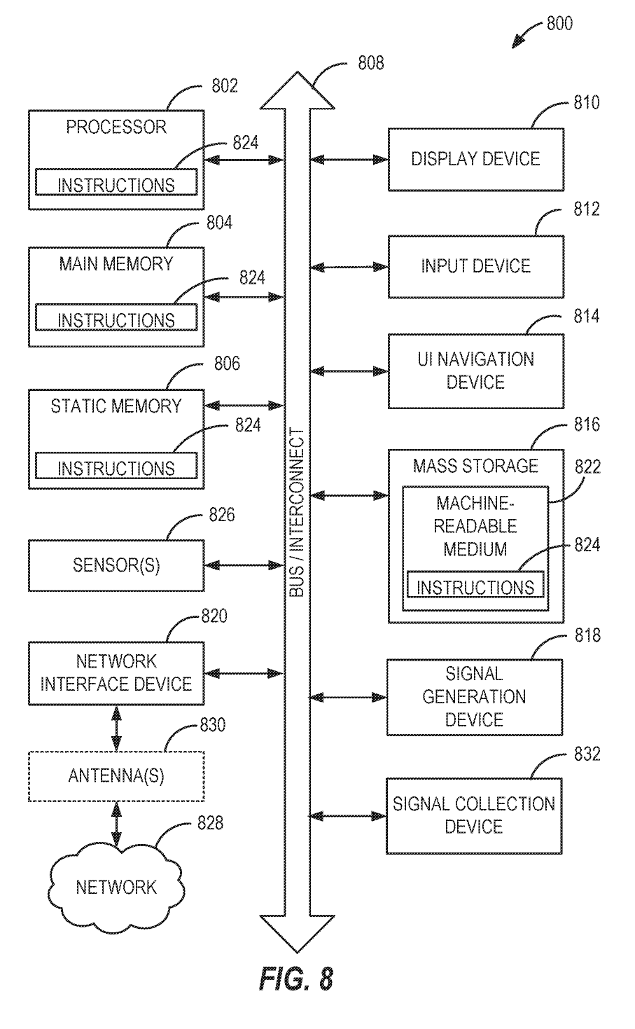

FIG. 8 is a block diagram illustrating an example computing system machine upon which any one or more of the methodologies herein discussed may be run. Computer system 800 may be embodied as a computing device, providing operations of the components featured in the various figures, including components of the centralized server 102, the client interaction computer system 112, the parameter server 232, the training processing servers 234, the client computing system 702, the server computing system 730, the verification computing system 740, or as an execution platform for the operations in flowcharts 500 and 600, or any other processing, storage, or computing platform or component described or referred to herein. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The computer system machine may be a personal computer (PC) that may or may not be portable (e.g., a notebook or a netbook), a tablet, a Personal Digital Assistant (PDA), a mobile telephone or smartphone, a thin client, a web appliance, a virtual machine host, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 800 includes a processor 802 (e.g., a central processing unit (CPU), a graphics processing unit (GPU) or both), a main memory 804 and a static memory 806, which communicate with each other via an interconnect 808 (e.g., a link, a bus, etc.). The computer system 800 may further include a video display unit 810, an alphanumeric input device 812 (e.g., a keyboard), and a user interface (UI) navigation device 814 (e.g., a mouse). In one example, the video display unit 810, input device 812 and UI navigation device 814 are a touch screen display. The computer system 800 may additionally include a storage device 816 (e.g., a drive unit), a signal generation device 818 (e.g., a speaker), a signal collection device 832, and a network interface device 820 (which may include or operably communicate with one or more antennas 830, transceivers, or other wireless communications hardware), and one or more sensors 826.

The storage device 816 includes a machine-readable medium 822 on which is stored one or more sets of data structures and instructions 824 (e.g., software) embodying or utilized by any one or more of the methodologies or functions described herein. The instructions 824 may also reside, completely or at least partially, within the main memory 804, static memory 806, and/or within the processor 802 during execution thereof by the computer system 800, with the main memory 804, static memory 806, and the processor 802 also constituting machine-readable media.

While the machine-readable medium 822 is illustrated in an example to be a single medium, the term “machine-readable medium” may include a single medium or multiple media (e.g., a centralized or distributed database, and/or associated caches and servers) that store the one or more instructions 824. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, optical media, and magnetic media. Specific examples of machine-readable media include non-volatile memory, including, by way of example, semiconductor memory devices (e.g., Electrically Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks.

The instructions 824 may further be transmitted or received over a communications network 828 using a transmission medium via the network interface device 820 utilizing any one of a number of well-known transfer protocols (e.g., HTTP). Examples of communication networks include a local area network (LAN), wide area network (WAN), the Internet, mobile telephone networks, Plain Old Telephone (POTS) networks, and wireless data networks (e.g., Wi-Fi, 3G, and 4G LTE/LTE-A or WiMAX networks). Such communications may also be facilitated using any number of personal area networks, LANs, and WANs, using any combination of wired or wireless transmission mediums. The term “transmission medium” shall be taken to include any intangible medium that is capable of storing, encoding, or carrying instructions for execution by the machine, and includes digital or analog communications signals or other intangible medium to facilitate communication of such software.

The embodiments described above may be implemented in one or a combination of hardware, firmware, and software. While some embodiments described herein illustrate only a single machine or device, the terms “system”, “machine”, or “device” shall also be taken to include any collection of machines or devices that individually or jointly execute a set (or multiple sets) of instructions to perform any one or more of the methodologies discussed herein.

Examples, as described herein, may include, or may operate on, logic or a number of components, modules, or mechanisms. Such components may be tangible entities (e.g., hardware) capable of performing specified operations and may be configured or arranged in a certain manner. In an example, circuits may be arranged (e.g., internally or with respect to external entities such as other circuits) in a specified manner to implement such components. In an example, the whole or part of one or more computer systems (e.g., a standalone, client or server computer system) or one or more hardware processors may be configured by firmware or software (e.g., instructions, an application portion, or an application) that operates to perform specified operations. In an example, the software may reside on a machine readable medium. In an example, the software, when executed by the underlying hardware, causes the hardware to perform the specified operations.

Accordingly, such components may be a tangible entity that is physically constructed, specifically configured (e.g., hardwired), or temporarily (e.g., transitorily) configured (e.g., programmed) to operate in a specified manner or to perform part or all of any operation described herein. Considering examples in which such components are temporarily configured, each of the components need not be instantiated at any one moment in time. For example, where the components comprise a general-purpose hardware processor configured using software, the general-purpose hardware processor may be configured as respective different components at different times. Software may accordingly configure a hardware processor, for example, to constitute a particular component at one instance of time and to constitute a different component at a different instance of time.

Additional examples of the presently described method, system, and device embodiments are suggested according to the structures and techniques described above and specified in the following claims.

For example, Example 1 of the subject matter described herein may be embodied by a method for training a deep neural network from workflow activities in a computing device performed by electronic operations executed by the computing device, with the computing device having at least one processor and at least one memory, and with the electronic operations comprising: generating model output of source data in a graphical user interface of the computing device, wherein the model output of the source data is produced using: execution of an algorithm of a deep neural network on a set of source data to perform automated workflow actions, or manual specification of a series of workflow actions for an algorithm of the deep neural network based on human user input; receiving, in the graphical user interface, user modification or user acceptance of the model output of the source data generated in the graphical user interface, generating updated parameters to update the algorithm of the deep neural network, wherein the updated parameters to update the algorithm are based on the user modification or user acceptance that is received in the graphical user interface; and transmitting, to a parameter server, the updated parameters to update the algorithm of the deep neural network.

In Example 2, the subject matter of Example 1 optionally includes the updated parameters to update the algorithm of the deep neural network to provide reinforcement of weights used by the algorithm, in response to user input received with the computing device, wherein the user input indicates the user acceptance that is received in the graphical user interface.

In Example 3, the subject matter of any one or more of Examples 1-2 optionally include: receiving, in the graphical user interface, user modification of the model output of the source data generated in the graphical user interface; wherein the updated parameters to update the algorithm of the deep neural network provide changes of weights used by the algorithm, in response to user input received with the computing device; and wherein the user input indicates the user modification that is received in the graphical user interface.

In Example 4, the subject matter of Example 3 optionally includes: calculating a difference between the model output of the source data and updated output of the source data, wherein the updated output of the source data is provided from the user modification of the model output; wherein the updated parameters to update the algorithm of the deep neural network provide an indication of the calculated difference between the model output of the source data and the updated output of the source data.

In Example 5, the subject matter of Example 4 optionally includes calculating the difference between the model output of the source data and updated output that includes calculating changes to a plurality of weights applied by the algorithm of the deep neural network, wherein the updated parameters to update the algorithm of the deep neural network indicate the changes to the plurality of weights.

In Example 6, the subject matter of any one or more of Examples 1-5 optionally include: executing a user interaction workflow, the user interaction workflow including the operations of generating the model output of the source data, the user interaction workflow performed with an execution of a first version of the algorithm of the deep neural network; executing a parallel algorithm workflow concurrently with the user interaction workflow, the parallel algorithm workflow including the operations of generating an expected model output of the source data, wherein the expected model output of the source data is produced using an execution of a second version of the algorithm of the deep neural network, wherein the second version of the algorithm of the deep neural network operates with received parameters provided from the parameter server; receiving, in the graphical user interface, user modifications of the model output of the source data generated in the graphical user interface, prior to receiving the user acceptance; and determining a difference in parameters used in the first version of the algorithm of the deep neural network and the parameters used in the second version of the algorithm of the deep neural network; wherein transmitting the updated parameters for training of the deep neural network includes transmitting the determined difference in parameters.

In Example 7, the subject matter of any one or more of Examples 1-6 optionally include the source data being medical imaging data that represents one or more human anatomical features in one or more medical images, wherein the algorithm of the deep neural network performs automated workflow operations, including at least one of; detection, segmentation, quantification, or prediction operations, and wherein the automated workflow operations are performed on identified characteristics of one or more of the human anatomical features in the one or more medical images.

In Example 8, the subject matter of Example 7 optionally includes the model output of the source data including a change in visualization to a display of the one or more human anatomical features in the one or more medical images, wherein the change in visualization to the display of the one or more human anatomical features in the one or more medical images is further changed by a user modification received with the computing device, wherein the user modification received with the computing device causes a further change to the visualization to the display of the one or more of the human anatomical features, the user modification received from a first user input received with the computing device via a human input device, and wherein the user acceptance received with the computing device causes an acceptance of the further change to the visualization of the display of the one or more of the human anatomical features, the user acceptance received from a second user input received with the computing device via the human input device.

In Example 9, the subject matter of any one or more of Examples 1-8 optionally include: receiving, from the parameter server, subsequent received parameters for subsequent operation of the algorithm for the deep neural network; and operating the algorithm for the deep neural network on a subsequent set of source data, based on use of the subsequent received parameters with the algorithm of the deep neural network.

As yet another example, Example 10, the subject matter described herein may be embodied by a non-transitory machine-readable medium, the machine-readable medium including instructions, which when executed by a machine having a hardware processor, causes the machine to perform aspects of the client- or server-performed method(s) to: generate model output of source data in a graphical user interface, wherein the model output of the source data is produced using: execution of an algorithm of a deep neural network on a set of source data, or manual specification of a series of workflow actions for an algorithm of the deep neural network based on human user input; receive, in the graphical user interface, user modification or user acceptance of the model output of the source data generated in the graphical user interface; generate updated parameters to update the algorithm of the deep neural network, wherein the updated parameters to update the algorithm are based on the user modification or user acceptance that is received in the graphical user interface; and transmit, to a parameter server, the updated parameters to update the algorithm of the deep neural network.

In Example 11, the subject matter of Example 10 optionally includes wherein the updated parameters to update the algorithm of the deep neural network provide reinforcement of weights used by the algorithm, in response to received user input, and wherein the received user input indicates the user acceptance that is received in the graphical user interface.

In Example 12, the subject matter of any one or more of Examples 10-11 optionally include the medium further including instructions that cause the machine to perform operations that: receive, in the graphical user interface, user modification of the model output of the source data generated in the graphical user interface; wherein the updated parameters to update the algorithm of the deep neural network provide changes of weights used by the algorithm, in response to received user input; and wherein the received user input indicates the user modification that is received in the graphical user interface.

In Example 13, the subject matter of Example 12 optionally includes the medium further including instructions that cause the machine to perform operations that: calculate a difference between the model output of the source data and updated output of the source data, wherein the updated output of the source data is provided from the user modification of the model output; wherein the updated parameters to update the algorithm of the deep neural network provide an indication of the calculated difference between the model output of the source data and the updated output of the source data.

In Example 14, the subject matter of Example 13 optionally includes wherein calculating the difference between the model output of the source data and updated output includes calculating changes to a plurality of weights applied by the algorithm of the deep neural network, and wherein the updated parameters to update the algorithm of the deep neural network indicate the changes to the plurality of weights.

In Example 15, the subject matter of any one or more of Examples 10-14 optionally include the medium including instructions that cause the machine to perform operations that: execute a user interaction workflow, the user interaction workflow including the operations of generating the model output of the source data, the user interaction workflow performed with an execution of a first version of the algorithm of the deep neural network; execute a parallel algorithm workflow concurrently with the user interaction workflow, the parallel algorithm workflow including the operations of generating an expected model output of the source data, wherein the expected model output of the source data is produced using an execution of a second version of the algorithm of the deep neural network, wherein the second version of the algorithm of the deep neural network operates with received parameters provided from the parameter server; receive, in the graphical user interface, user modifications of the model output of the source data generated in the graphical user interface, prior to receiving the user acceptance; and determine a difference in parameters used in the first version of the algorithm of the deep neural network and the parameters used in the second version of the algorithm of the deep neural network; wherein transmitting the updated parameters for training of the deep neural network includes transmitting the determined difference in parameters.

In Example 16, the subject matter of any one or more of Examples 10-15 optionally include wherein the source data is medical imaging data that represents one or more human anatomical features in one or more medical images, and wherein the algorithm of the deep neural network performs automated workflow operations, including at least one of: detection, segmentation, quantification, or prediction operations, and wherein the automated workflow operations are performed on identified characteristics of one or more of the human anatomical features in the one or more medical images.

In Example 17, the subject matter of Example 16 optionally includes wherein the model output of the source data includes a change in visualization to a display of the one or more human anatomical features in the one or more medical images, and wherein the change in visualization to the display of the one or more human anatomical features in the one or more medical images is further changed by user modification, wherein the user modification causes a further change to the visualization to the display of the one or more of the human anatomical features, the user modification received from a first user input received via a human input device, and wherein the user acceptance causes an acceptance of the further change to the visualization of the display of the one or more of the human anatomical features, the user acceptance received from a second user input received via the human input device.

In Example 18, the subject matter of any one or more of Examples 10-17 optionally include the medium including instructions that cause the machine to perform operations that: receive, from the parameter server, subsequent received parameters for subsequent operation of the algorithm for the deep neural network; and operate the algorithm for the deep neural network on a subsequent set of source data, based on use of the subsequent received parameters with the algorithm of the deep neural network.

As another example, Example 19, the subject matter described herein may be embodied by a method performed by a device (e.g., a computer system) executing a software application, the software application executed via electronic operations performed by at least one processor and at least one memory to: generate model output of source data in a graphical user interface of the computing device, wherein the model output of the source data is produced using: execution of an algorithm of a deep neural network on a set of source data to perform automated workflow actions, or manual specification of a series of workflow actions for an algorithm of the deep neural network based on human user input; receive, in the graphical user interface, user modification or user acceptance of the model output of the source data generated in the graphical user interface; generate updated parameters to update the algorithm of the deep neural network, wherein the updated parameters to update the algorithm are based on the user modification or user acceptance that is received in the graphical user interface; and transmit, to a parameter server, the updated parameters to update the algorithm of the deep neural network.

In Example 20, the subject matter of Example 19 optionally includes the device performing any of the electronic operations, such as executing the instructions provided by a machine readable medium, indicated in Examples 1-19.

As another example, Example 21, the subject matter described herein may be embodied by a system, comprising: a medical imaging viewing system, comprising processing circuitry having at least one processor and at least one memory, the processing circuitry to execute instructions with the at least one processor and the at least one memory to: generate model output of source data in a graphical user interface, wherein the model output of the source data is produced using execution of an algorithm of a deep neural network on a set of source data; receive, in the graphical user interface, user acceptance of the model output of the source data generated in the graphical user interface; generate updated parameters to update the algorithm of the deep neural network, wherein the updated parameters to update the algorithm are based on the user acceptance that is received in the graphical user interface; and transmit, to a parameter server, the updated parameters to update the algorithm of the deep neural network.

In Example 22, the subject matter of Example 21 optionally includes the processing circuitry to execute further instructions with the at least one processor and the at least one memory to: calculate the updated parameters to update the algorithm of the deep neural network to provide reinforcement of weights used by the algorithm, in response to received user input; wherein the user input indicates the user acceptance that is received in the graphical user interface; wherein the source data is medical imaging data that represents human anatomical features in one or more medical images; wherein the algorithm of the deep neural network performs automated workflow operations, including at least one of: detection, segmentation, quantification, or prediction operations; and wherein the automated workflow operations are performed on identified characteristics of one or more of the human anatomical features in the one or more medical images.

In Example 23, the subject matter of any one or more of Examples 21-22 optionally include the processing circuitry to execute further instructions with the at least one processor and the at least one memory to: receive, in the graphical user interface, user modification of the model output of the source data generated in the graphical user interface; and calculate a difference between the model output of the source data and updated output of the source data, wherein the updated output of the source data is provided from the user modification of the model output; wherein the updated parameters to update the algorithm of the deep neural network provide changes of weights used by the algorithm, in response to received user input; wherein the updated parameters to update the algorithm of the deep neural network provide an indication of the calculated difference between the model output of the source data and the updated output of the source data; and wherein the user input indicates the user modification that is received in the graphical user interface.

In Example 24, the subject matter of any one or more of Examples 21-23 optionally include the processing circuitry to execute further instructions with the at least one processor and the at least one memory to: execute a user interaction workflow, the user interaction workflow including operations to generate the model output of the source data, the user interaction workflow performed with an execution of a first version of the algorithm of the deep neural network; execute a parallel algorithm workflow concurrently with the user interaction workflow, the parallel algorithm workflow including the operations of generating an expected model output of the source data, wherein the expected model output of the source data is produced using an execution of a second version of the algorithm of the deep neural network, wherein the second version of the algorithm of the deep neural network operates with received parameters provided from the parameter server; receive, in the graphical user interface, user modifications of the model output of the source data generated in the graphical user interface, prior to receiving the user acceptance; and determine a difference in parameters used in the first version of the algorithm of the deep neural network and the parameters used in the second version of the algorithm of the deep neural network; wherein transmission of the updated parameters for training of the deep neural network includes transmission of the determined difference in parameters.

Example 25 includes an apparatus comprising means for performing any of the electronic operations indicated in any one or more of Examples 1-24.

Other non-limiting examples may be configured to operate separately, or can be combined in any permutation or combination with any one or more of the other examples provided above, in the following claims, or throughout the present disclosure.

What is claimed is:

1. A method for training a deep neural network from workflow activities in a computing device, performed by electronic operations executed by the computing device, with the computing device having at least one processor and at least one memory, and with the electronic operations comprising:
generating model output of source data in a graphical user interface of the computing device, wherein the model output of the source data is produced using execution of an algorithm of a deep neural network on a set of source data;
receiving, in the graphical user interface, user acceptance of the model output of the source data generated in the graphical user interface;
generating updated parameters to update the algorithm of the deep neural network, wherein the updated parameters to update the algorithm are based on the user acceptance that is received in the graphical user interface; and
transmitting, to a parameter server, the updated parameters to update the algorithm of the deep neural network.

2. The method of claim 1,
wherein the updated parameters to update the algorithm of the deep neural network provide reinforcement of weights used by the algorithm, in response to user input received with the computing device, and
wherein the user input indicates the user acceptance that is received in the graphical user interface.

3. The method of claim 1, the electronic operations comprising:
receiving, in the graphical user interface, user modification of the model output of the source data generated in the graphical user interface;
wherein the updated parameters to update the algorithm of the deep neural network provide changes of weights used by the algorithm, in response to user input received with the computing device; and
wherein the user input indicates the user modification that is received in the graphical user interface.

4. The method of claim 3, the electronic operations comprising:
calculating a difference between the model output of the source data and updated output of the source data, wherein the updated output of the source data is provided from the user modification of the model output;
wherein the updated parameters to update the algorithm of the deep neural network provide an indication of the calculated difference between the model output of the source data and the updated output of the source data.

5. The method of claim 4,
wherein calculating the difference between the model output of the source data and updated output includes calculating changes to a plurality of weights applied by the algorithm of the deep neural network, and
wherein the updated parameters to update the algorithm of the deep neural network indicate the changes to the plurality of weights.

6. The method of claim 1, the electronic operations comprising:
executing a user interaction workflow, the user interaction workflow including the operations of generating the model output of the source data, the user interaction workflow performed with an execution of a first version of the algorithm of the deep neural network;
executing a parallel algorithm workflow concurrently with the user interaction workflow, the parallel algorithm workflow including the operations of generating an expected model output of the source data, wherein the expected model output of the source data is produced using an execution of a second version of the algorithm of the deep neural network, wherein the second version of the algorithm of the deep neural network operates with received parameters provided from the parameter server;
receiving, in the graphical user interface, user modifications of the model output of the source data generated in the graphical user interface, prior to receiving the user acceptance; and
determining a difference in parameters used in the first version of the algorithm of the deep neural network and the parameters used in the second version of the algorithm of the deep neural network;
wherein transmitting the updated parameters for training of the deep neural network includes transmitting the determined difference in parameters.

7. The method of claim 1,
wherein the source data is medical imaging data that represents one or more human anatomical features in one or more medical images,
wherein the algorithm of the deep neural network performs automated workflow operations, including at least one of: detection, segmentation, quantification, or prediction operations, and
wherein the automated workflow operations are performed on identified characteristics of one or more of the human anatomical features in the one or more medical images.

8. The method of claim 7,
wherein the model output of the source data includes a change in visualization to a display of the one or more human anatomical features in the one or more medical images, and wherein the change in visualization to the display of the one or more human anatomical features in the one or more medical images is further changed by a user modification received with the computing device,
wherein the user modification received with the computing device causes a further change to the visualization to the display of the one or more of the human anatomical features, the user modification received from a first user input received with the computing device via a human input device, and
wherein the user acceptance received with the computing device causes an acceptance of the further change to the visualization of the display of the one or more of the human anatomical features, the user acceptance received from a second user input received with the computing device via the human input device.

9. The method of claim 1, the electronic operations comprising:
receiving, from the parameter server, subsequent received parameters for subsequent operation of the algorithm for the deep neural network; and
operating the algorithm for the deep neural network on a subsequent set of source data, based on use of the subsequent received parameters with the algorithm of the deep neural network.

10. At least non-transitory machine-readable medium, the machine-readable medium including instructions, which when executed by a machine having a hardware processor, causes the machine to perform operations that:
generate model output of source data in a graphical user interface, wherein the model output of the source data is produced using execution of an algorithm of a deep neural network on a set of source data;
receive, in the graphical user interface, user acceptance of the model output of the source data generated in the graphical user interface;
generate updated parameters to update the algorithm of the deep neural network, wherein the updated parameters to update the algorithm are based on the user acceptance that is received in the graphical user interface; and
transmit, to a parameter server, the updated parameters to update the algorithm of the deep neural network.

11. The machine-readable medium of claim 10,
wherein the updated parameters to update the algorithm of the deep neural network provide reinforcement of weights used by the algorithm, in response to received user input, and
wherein the received user input indicates the user acceptance that is received in the graphical user interface.

12. The machine-readable medium of claim 10, the medium further including instructions that cause the machine to perform operations that:
receive, in the graphical user interface, user modification of the model output of the source data generated in the graphical user interface;
wherein the updated parameters to update the algorithm of the deep neural network provide changes of weights used by the algorithm, in response to received user input; and
wherein the received user input indicates the user modification that is received in the graphical user interface.

13. The machine-readable medium of claim 12, the medium further including instructions that cause the machine to perform operations that:
calculate a difference between the model output of the source data and updated output of the source data, wherein the updated output of the source data is provided from the user modification of the model output;
wherein the updated parameters to update the algorithm of the deep neural network provide an indication of the calculated difference between the model output of the source data and the updated output of the source data.

14. The machine-readable medium of claim 13,
wherein calculating the difference between the model output of the source data and updated output includes calculating changes to a plurality of weights applied by the algorithm of the deep neural network, and
wherein the updated parameters to update the algorithm of the deep neural network indicate the changes to the plurality of weights.

15. The machine-readable medium of claim 10, the medium including instructions that cause the machine to perform operations that:
execute a user interaction workflow, the user interaction workflow including the operations of generating the model output of the source data, the user interaction workflow performed with an execution of a first version of the algorithm of the deep neural network;
execute a parallel algorithm workflow concurrently with the user interaction workflow, the parallel algorithm workflow including the operations of generating an expected model output of the source data, wherein the expected model output of the source data is produced using an execution of a second version of the algorithm of the deep neural network, wherein the second version of the algorithm of the deep neural network operates with received parameters provided from the parameter server;
receive, in the graphical user interface, user modifications of the model output of the source data generated in the graphical user interface, prior to receiving the user acceptance; and
determine a difference in parameters used in the first version of the algorithm of the deep neural network and the parameters used in the second version of the algorithm of the deep neural network;
wherein transmitting the updated parameters for training of the deep neural network includes transmitting the determined difference in parameters.

16. The machine-readable medium of claim 10,
wherein the source data is medical imaging data that represents one or more human anatomical features in one or more medical images, and
wherein the algorithm of the deep neural network performs automated workflow operations, including at least one of: detection, segmentation, quantification, or prediction operations, and
wherein the automated workflow operations are performed on identified characteristics of one or more of the human anatomical features in the one or more medical images.

17. The machine-readable medium of claim 16,
wherein the model output of the source data includes a change in visualization to a display of the one or more human anatomical features in the one or more medical images, and wherein the change in visualization to the display of the one or more human anatomical features in the one or more medical images is further changed by user modification,
wherein the user modification causes a further change to the visualization to the display of the one or more of the human anatomical features, the user modification received from a first user input received via a human input device, and
wherein the user acceptance causes an acceptance of the further change to the visualization of the display of the one or more of the human anatomical features, the user acceptance received from a second user input received via the human input device.

18. The machine-readable medium of claim 10, the medium including instructions that cause the machine to perform operations that:
receive, from the parameter server, subsequent received parameters for subsequent operation of the algorithm for the deep neural network; and
operate the algorithm for the deep neural network on a subsequent set of source data, based on use of the subsequent received parameters with the algorithm of the deep neural network.

19. A system, comprising:
a medical imaging viewing system, comprising processing circuitry having at least one processor and at least one memory, the processing circuitry to execute instructions with the at least one processor and the at least one memory to:
generate model output of source data in a graphical user interface, wherein the model output of the source data is produced using execution of an algorithm of a deep neural network on a set of source data;
receive, in the graphical user interface, user acceptance of the model output of the source data generated in the graphical user interface;
generate updated parameters to update the algorithm of the deep neural network, wherein the updated parameters to update the algorithm are based on the user acceptance that is received in the graphical user interface; and
transmit, to a parameter server, the updated parameters to update the algorithm of the deep neural network.

20. The system of claim 19, the processing circuitry to execute further instructions with the at least one processor and the at least one memory to:
calculate the updated parameters to update the algorithm of the deep neural network to provide reinforcement of weights used by the algorithm, in response to received user input;
wherein the user input indicates the user acceptance that is received in the graphical user interface;
wherein the source data is medical imaging data that represents human anatomical features in one or more medical images;
wherein the algorithm of the deep neural network performs automated workflow operations, including at least one of: detection, segmentation, quantification, or prediction operations; and
wherein the automated workflow operations are performed on identified characteristics of one or more of the human anatomical features in the one or more medical images.

21. The system of claim 19, the processing circuitry to execute further instructions with the at least one processor and the at least one memory to:
receive, in the graphical user interface, user modification of the model output of the source data generated in the graphical user interface; and
calculate a difference between the model output of the source data and updated output of the source data, wherein the updated output of the source data is provided from the user modification of the model output;
wherein the updated parameters to update the algorithm of the deep neural network provide changes of weights used by the algorithm, in response to received user input;
wherein the updated parameters to update the algorithm of the deep neural network provide an indication of the calculated difference between the model output of the source data and the updated output of the source data; and
wherein the user input indicates the user modification that is received in the graphical user interface.

22. The system of claim 19, the processing circuitry to execute further instructions with the at least one processor and the at least one memory to:
execute a user interaction workflow, the user interaction workflow including operations to generate the model output of the source data, the user interaction workflow performed with an execution of a first version of the algorithm of the deep neural network;
execute a parallel algorithm workflow concurrently with the user interaction workflow, the parallel algorithm workflow including the operations of generating an expected model output of the source data, wherein the expected model output of the source data is produced using an execution of a second version of the algorithm of the deep neural network, wherein the second version of the algorithm of the deep neural network operates with received parameters provided from the parameter server;
receive, in the graphical user interface, user modifications of the model output of the source data generated in the graphical user interface, prior to receiving the user acceptance; and
determine a difference in parameters used in the first version of the algorithm of the deep neural network and the parameters used in the second version of the algorithm of the deep neural network;
wherein transmission of the updated parameters for training of the deep neural network includes transmission of the determined difference in parameters.
